(19) United States
(12) Patent Application Publication
(10) Pub. No.: US 2024/0107479 A1
(43) Pub. Date: Mar. 28, 2024

(54) Delay Measurement for Radio-Frequency Circuitry

(71) Applicant: Apple Inc., Cupertino, CA (US)

(72) Inventor: Andrea Camuffo, Munich (DE)

(21) Appl. No.: 17/950,484

(22) Filed: Sep. 22, 2022

(51) Int. Cl. H04W 56/00

(52) U.S. Cl. CPC H04W 56/0065

(57) ABSTRACT

An electronic device may include wireless circuitry with a processor, a transmitter, an antenna, and front end circuits coupled between the transmitter and the antenna. Front end circuits for a transmit path may be coupled to the antenna via an intervening radio-frequency coupler. The radio-frequency coupler may be coupled to a feedback receiver via a feedback path. A feedback signal may be provided to the processor via the feedback receiver. A corresponding transmit signal may be provided to the processor via time delay circuitry applying a time delay to the transmit signal. Delay measurement circuitry may perform parallelized cross-correlation operations across multiple iterations to determine the time delay to be applied to the transmit signal.

### FIELD

This disclosure relates generally to electronic devices and, more particularly, to electronic devices with wireless communications circuitry.

### BACKGROUND

Electronic devices can often be provided with wireless communications capabilities. An electronic device with wireless communications capabilities can have wireless communications circuitry with one or more antennas. Wireless transceiver circuitry in the wireless communications circuitry can use the antennas to transmit and receive radio-frequency signals.

In some instances, the wireless communications circuitry can include a feedback receiver configured to receive a radio-frequency feedback signal via a directional coupler coupled along a radio-frequency transmit path conveying a corresponding radio-frequency signal to be transmitted. It may be desirable to measure the time delay associated with a portion of the transmit and feedback paths to properly correlate the feedback signal to the transmit signal. It can be challenging to design a satisfactory delay measurement circuit.

### SUMMARY

An electronic device may include wireless communications circuitry with one or more processors, a transmitter (e.g., as part of a transceiver), an antenna, and front end circuits coupled between the transmitter and the antenna. The front end circuits for a transmit path may be coupled to the antenna via an intervening radio-frequency coupler. The radio-frequency coupler may be coupled to a feedback receiver (e.g., as part of the transceiver or separate from the transceiver) via a feedback path. A feedback signal may be provided to the processor via the feedback receiver. A corresponding transmit signal may be provided to the processor via time delay circuitry applying an appropriate time delay to the transmit signal. Delay measurement circuitry may perform parallelized cross-correlation operations (measurements) across multiple iterations to determine the appropriate time delay to be applied to the transmit signal via the time delay circuitry.

In particular, the delay measurement circuitry may include a bulk time delay circuit and multiple unit time delay circuits coupled in series. The delay measurement circuitry may include a first filter (e.g., a first low pass filter with adjustable filter bandwidth) and a first decimator both coupled to the bulk time delay circuit. The delay measurement circuitry may include multiple cross-correlation circuits, each coupled to a corresponding output terminal of a respective unit time delay circuit. The delay measurement circuitry may include a second filter (e.g., a second low pass filter with adjustable filter bandwidth) and a second decimator coupled to each of the multiple cross-correlation circuits. The output terminals of each of the multiple cross-correlation circuits may be coupled to the one or more processors and/or a separate control circuit. The multiple cross-correlation circuits may perform parallel cross-correlation operations across multiple iterations to converge on the final appropriate time delay to be applied to the transmit signal. The filter bandwidth for the filters may be increased, the decimation factor for the decimators may be decreased, the bulk time delay may be updated, and/or the unit time delay may be reduced across sequential iterations.

An aspect of the disclosure provides delay measurement circuitry that measures a time delay between two radio-frequency signals. The delay measurement circuitry can include a plurality of time delay circuits coupled in series. A first time delay circuit in the plurality of time delay circuit can be configured to receive a first radio-frequency signal. The delay measurement circuitry can include a plurality of cross-correlation circuits, each cross-correlation circuit being coupled to a corresponding time delay circuit in the plurality of time delay circuits and configured to receive to receive a same second radio-frequency signal. The delay measurement circuitry can include one or more processors coupled to the plurality of cross-correlation circuits and configured to determine a time delay between the first radio-frequency signal and the second radio-frequency signal based at least in part on cross-correlation results from the plurality of cross-correlation circuits.

The delay measurement circuitry can further include a first decimator coupled to the first time delay circuit and a second decimator coupled to each cross-correlation circuit in the plurality of cross-correlation circuits. The delay measurement circuitry can further include a first filter coupled to the first decimator and a second filter coupled to the second decimator. The first decimator and the second decimator can be synchronized in operation to exhibit a same decimation factor. The first filter and the second filter can be synchronized in operation to exhibit a same bandwidth. The plurality of time delay circuits can be configured to apply a first set of time delays during a first iteration of delay measurements and the plurality of delay circuits can be configured to apply a second set of time delays during a second iteration of delay measurements.

An aspect of the disclosure provides wireless circuitry. The wireless circuitry can include a transmitter, a feedback receiver coupled to the transmitter via a radio-frequency coupler, and one or more processors configured to receive a feedback signal from the feedback receiver and a delayed transmit signal applied with a time delay from the transmitter. The wireless circuitry can include time delay measurement circuitry configured to determine the time delay. The time delay measurement circuitry can include time delay circuitry configured to receive a transmit signal, and a plurality of cross-correlation circuits each coupled to the time delay circuitry and each configured to receive the feedback signal.

An aspect of the disclosure provides a method of time delay determination. The method can include filtering a first radio-frequency signal, decimating the filtered first radio-frequency signal, delaying the decimated and filtered first radio-frequency signal, filtering a second radio-frequency signal, and decimating the filtered second radio-frequency signal. The method can include determining a time delay between the first radio-frequency signal and the second radio-frequency signal based at least in part on cross-correlating the delayed, decimated, and filtered first radio-frequency signal and the decimated and filtered second radio-frequency signal.

### BRIEF DESCRIPTION OF THE DRAWINGS

FIG. 1 is a diagram of an illustrative electronic device having wireless communications circuitry in accordance with some embodiments.

FIG. 2 is a diagram of illustrative wireless communications circuitry having transmitter and receiver circuitry in accordance with some embodiments.

FIG. 3 is a diagram of illustrative wireless communications circuitry having a transmit path, a corresponding feedback path, and time delay circuitry coupled to the transmit path in accordance with some embodiments.

FIG. 4 is a diagram of illustrative delay measurement circuitry having multiple serially-coupled time delay circuits and multiple cross-correlation circuits in accordance with some embodiments.

FIG. 5 is a diagram of illustrative delay measurement circuitry having synchronized filters and decimators coupled to both the transmit path and the feedback path in accordance with some embodiments.

FIG. 6 is a flowchart of illustrative operations for using the delay measurement circuitry of the type shown in FIG. 5 to perform an iterative delay search operation in accordance with some embodiments.

### DETAILED DESCRIPTION

An electronic device may be provided with processing circuitry and wireless transceiver circuitry. The processing circuitry may provide the wireless transceiver circuitry such as a transmitter circuit with a transmit signal to be output as a radio-frequency transmit signal, radio-frequency front end circuits for modifying (e.g., amplifying) the radio-frequency transmit signal, and an antenna for radiating the modified signal.

A radio-frequency coupler may be coupled along the transmit path (e.g., between the front end circuits and the antenna) to provide a feedback receiver (e.g., implemented as part of the transceiver or separate from the transceiver) with a feedback signal along a feedback path. The processing circuitry may use the feedback signal in conjunction with the transmit signal to perform certain operations (e.g., digital pre-distortion, error vector magnitude estimation, etc.). In particular, a time delay used to compensate for the delay of the radio-frequency (transmit and/or feedback) signal passing through at least a portion of the transmit path and/or the feedback path may first be applied to the transmit signal (e.g., via time delay circuitry coupled to the transmit path) prior to the transmit signal being conveyed to the processing circuitry.

Delay measurement circuitry may receive the transmit signal and the feedback signal, delay the transmit signal by various amounts of time, and perform parallel cross-correlation operations to correlate differently delayed versions of the transmit signal with the feedback signal. In particular, the delay measurement circuitry may include synchronized filters and synchronized decimators configured to process the transmit signal (prior to being delayed) and to process the feedback signal. Configured in this manner, the delay measurement circuitry may be configured to perform the delay measurement in an iterative manner (e.g., by adjusting the low pass filters, decimators, delay units, etc., across sequential iterations) to converge on the appropriate time delay to be applied to the transmit signal. The present embodiments describe various implementations of delay measurement circuitry configured to perform time delay measurements using a parallel and/or iterative scheme which can be used to quicken the determination of a time delay between signals while maintaining accuracy.

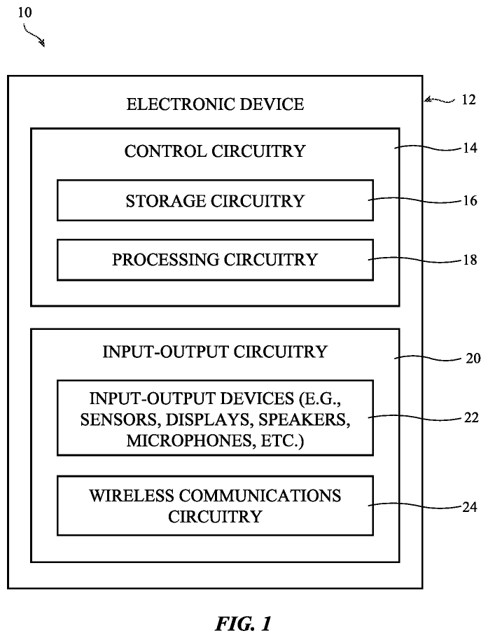

FIG. 1 is a diagram of an electronic device such as electronic device 10 that can be provided with such delay measurement circuitry. Electronic device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the schematic diagram FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more microprocessors, microcontrollers, digital signal processors, host processors, baseband processor integrated circuits, application processors, application specific integrated circuits, central processing units (CPUs), general purpose processors, or other types of processors. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 5G New Radio (NR) protocols, etc.), MIMO protocols, antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays, light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, electronic pencil (e.g., a stylus), and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless communications circuitry such as wireless communications circuitry 24 (sometimes referred to herein as wireless circuitry 24) for wirelessly conveying radio-frequency signals. While control circuitry 14 is shown separately from wireless communications circuitry 24 for the sake of clarity, wireless communications circuitry 24 may include processing circuitry that forms a part of processing circuitry 18 and/or storage circuitry that forms a part of storage circuitry 16 of control circuitry 14 (e.g., portions of control circuitry 14 may be implemented on wireless communications circuitry 24). As an example, control circuitry 14 (e.g., processing circuitry 18) may include processor circuitry or other control components that form a part of wireless communications circuitry 24.

Wireless communications circuitry 24 may include radio-frequency (RF) transceiver circuitry formed from one or more integrated circuits, power amplifier circuitry configured to amplify uplink radio-frequency signals (e.g., radio-frequency signals transmitted by device 10 to an external device), low-noise amplifiers configured to amplify downlink radio-frequency signals (e.g., radio-frequency signals received by device 10 from an external device), passive radio-frequency components, one or more antennas, transmission lines, and other circuitry for handling radio-frequency wireless signals. Wireless signals can also be sent using light (e.g., using infrared communications).

Wireless circuitry 24 may include radio-frequency transceiver circuitry for handling transmission and/or reception of radio-frequency signals in various radio-frequency communications bands. For example, the radio-frequency transceiver circuitry may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz), or other cellular communications bands between about 600 MHz and about 5000 MHz (e.g., 3G bands, 4G LTE bands, 5G New Radio Frequency Range 1 (FR1) bands below 10 GHz, 5G New Radio Frequency Range 2 (FR2) bands at millimeter and centimeter wavelengths between 20 and 60 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), an ultra-wideband (UWB) communications band supported by the IEEE 802.15.4 protocol and/or other UWB communications protocols (e.g., a first UWB communications band at 6.5 GHz and/or a second UWB communications band at 8.0 GHz), and/or any other desired communications bands. The communications bands handled by such radio-frequency transceiver circuitry may sometimes be referred to herein as frequency bands or simply as “bands,” and may span corresponding ranges of frequencies. In general, the radio-frequency transceiver circuitry within wireless circuitry 24 may cover (handle) any desired frequency bands of interest.

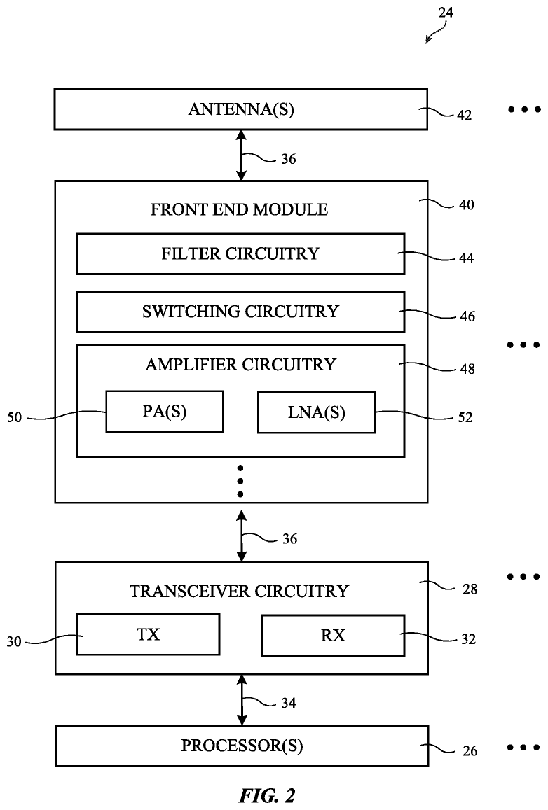

FIG. 2 is a diagram showing illustrative components within wireless circuitry 24. As shown in FIG. 2, wireless circuitry 24 may include a processor such as processor 26, radio-frequency (RF) transceiver circuitry such as radio-frequency transceiver 28, radio-frequency front end circuitry such as radio-frequency front end module (FEM) 40, and antenna(s) 42. Processor 26 may be a baseband processor, application processor, general purpose processor, microprocessor, microcontroller, digital signal processor, host processor, or other type of processor. Processor 26 may be coupled to transceiver 28 over path 34. Transceiver 28 may be coupled to antenna 42 via radio-frequency transmission line path 36. Radio-frequency front end module 40 may be disposed on radio-frequency transmission line path 36 between transceiver 28 and antenna 42.

In the example of FIG. 2, wireless circuitry 24 is illustrated as including only a single processor 26, a single transceiver 28, a single front end module 40, and a single antenna 42 for the sake of clarity. In general, wireless circuitry 24 may include any desired number of processors 26, any desired number of transceivers 36, any desired number of front end modules 40, and any desired number of antennas 42. Each processor 26 may be coupled to one or more transceiver 28 over respective paths 34. Each transceiver 28 may include a transmitter circuit 30 configured to output uplink signals to antenna 42, may include a receiver circuit 32 configured to receive downlink signals from antenna 42, and may be coupled to one or more antennas 42 over respective radio-frequency transmission line paths 36. Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module disposed thereon.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path such that is coupled to the positive antenna feed terminal on antenna 42. Radio-frequency transmission line path 36 may have a ground transmission line signal path that is coupled to the ground antenna feed terminal on antenna 42. This example is merely illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards.

In performing wireless transmission, processor(s) 26 may provide transmit signals (e.g., digital or baseband signals) to transceiver 28 over path 34. Transceiver 28 may further include circuitry for converting the transmit (baseband) signals received from processor 26 into corresponding radio-frequency signals. For example, transceiver circuitry 28 may include mixer circuitry for up-converting (or modulating) the transmit (baseband) signals to radio-frequencies prior to transmission over antenna 42. The example of FIG. 2 in which processor 26 communicates with transceiver 28 is merely illustrative. In general, transceiver 28 may communicate with a baseband processor, an application processor, general purpose processor, a microcontroller, a microprocessor, or one or more processors within circuitry 18. Transceiver circuitry 28 may also include digital-to-analog converter (DAC) and/or analog-to-digital converter (ADC) circuitry for converting signals between digital and analog domains. Transceiver 28 may use transmitter (TX) 30 to transmit the radio-frequency signals over antenna 42 via radio-frequency transmission line path 36 and front end module 40. Antenna 42 may transmit the radio-frequency signals to external wireless equipment by radiating the radio-frequency signals into free space.

In performing wireless reception, antenna 42 may receive radio-frequency signals from the external wireless equipment. The received radio-frequency signals may be conveyed to transceiver 28 via radio-frequency transmission line path 36 and front end module 40. Transceiver 28 may include circuitry such as receiver (RX) 32 for receiving signals from front end module 40 and for converting the received radio-frequency signals into corresponding baseband signals. For example, transceiver 28 may include mixer circuitry for down-converting (or demodulating) the received radio-frequency signals to baseband frequencies prior to conveying the received signals to processor 26 over path 34.

Front end module (FEM) 40 may include radio-frequency front end circuitry that operates on the radio-frequency signals conveyed (transmitted and/or received) over radio-frequency transmission line path 36. FEM 40 may, for example, include front end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifier circuits 50 and/or one or more low-noise amplifier circuits 52), impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to adjust the frequency response and wireless performance of antenna 42 over time.

Transceiver 28 may be separate from front end module 40. For example, transceiver 28 may be formed on another substrate such as the main logic board of device 10, a rigid printed circuit board, or flexible printed circuit that is not a part of front end module 40. While control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, processor 26 and/or portions of transceiver 28 (e.g., a host processor on transceiver 28) may form a part of control circuitry 14. Control circuitry 14 (e.g., portions of control circuitry 14 formed on processor 26, portions of control circuitry 14 formed on transceiver 28, and/or portions of control circuitry 14 that are separate from wireless circuitry 24) may provide control signals (e.g., over one or more control paths in device 10) that control the operation of front end module 40.

Transceiver circuitry 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband communications protocols, and/or any other desired radio-frequency transceiver circuitry for covering any other desired communications bands of interest.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna structures, slot antenna structures, planar inverted-F antenna structures, helical antenna structures, monopole antennas, dipoles, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

In some illustrative configurations described herein as an example, wireless communications circuitry 24 may include one or more feedback paths along each of which a corresponding feedback receiver is coupled. A feedback receiver may be implemented in a similar manner as receiver 32 described in connection with FIG. 2 and may therefore sometimes be referred to herein as feedback receiver 32. As examples, feedback receiver 32 may be formed as part of transceiver 28 that includes a corresponding transmitter 30 or, if desired, may be formed separately from transceiver 28.

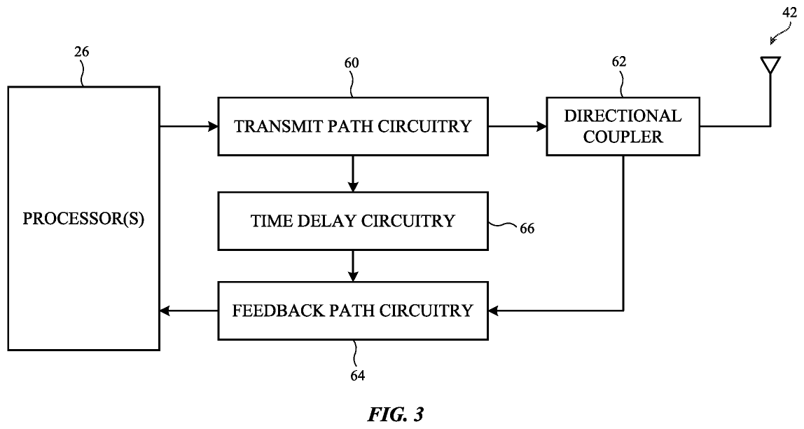

FIG. 3 is a diagram of an illustrative portion of wireless communications circuitry 24 that includes feedback path circuitry such as a feedback receiver, among other elements. As shown in FIG. 3, one or more processors 26 (sometimes referred to herein as processing circuitry 26) may be coupled to transmit path circuitry 60. Transmit path circuitry 60 may be coupled to antenna 42 (e.g., a single antenna element or multiple antenna elements arranged in an array) via an intervening radio-frequency coupler such as directional coupler 62. Based on the radio-frequency transmit signal provided from a radio-frequency front end circuit such as a power amplifier in transmit path circuitry 60 to antenna 42, directional coupler 62 may generate a corresponding radio-frequency feedback signal. Feedback path circuitry 64 may be coupled to directional coupler 62 and receive this radio-frequency feedback signal from directional coupler 62. Feedback path circuitry 64 may be coupled to one or more processors 26 and may convey this feedback signal to one or more processors 26.

Transmit path circuitry 60 and feedback path circuitry 64 may each include any of the circuitry described in connection with FIG. 2 that is coupled between processor(s) 26 and antenna(s) 42. In particular, transmit path circuitry 60 may include a transmitter circuit 30 coupled between processor(s) 26 and analog radio-frequency front end circuits in circuitry 60 coupled along the transmit path. As examples, transmitter 30 may include digital front end circuits and a radio-frequency digital-to-analog converter between the digital front end circuits and the analog radio-frequency front end circuits. The analog radio-frequency front end circuits in circuitry 60 may include any of the circuitry described in connection with front end module 40 in FIG. 2 such as a power amplifier coupled along the transmit path and configured to output the amplified radio-frequency transmit signal to antenna 42 through directional coupler 62.

Feedback path circuitry 64 may include analog radio-frequency front end circuits coupled between a feedback receiver circuit 32 and directional coupler 62. Feedback receiver 32 may be coupled between processor(s) 26 and the analog radio-frequency front end circuits in circuitry 64 along the feedback path. As examples, feedback receiver 32 may include digital front end circuits and a radio-frequency analog-to-digital converter between the digital front end circuits and the analog radio-frequency front end circuits. The analog radio-frequency front end circuits in circuitry 64 may include any of the circuitry described in connection with front end module 40 in FIG. 2 such as a low noise amplifier coupled along the feedback path and configured to receive the feedback signal from directional coupler 62.

While coupler 62 is shown and described to be a directional coupler, this configuration is illustrative of one of many other examples. If desired, coupler 62 (sometimes referred to herein generally as radio-frequency coupler 62) may be implemented using other types of radio-frequency couplers, if desired. In particular, radio-frequency coupler 62 may be any device coupled to a radio-frequency transmit path that can sample a portion of the transmit signal, directly by splitting the transmit signal into multiple portions one of which is passed along the feedback path and one of which is conveyed using the antenna, indirectly by using the transmit signal to induce (via capacitive or inductive coupling) a corresponding signal on the feedback path, or by using any other suitable configurations. As examples, a radio-frequency coupler can be implemented using a directional coupler, a dual directional coupler, a (90 degree or 180 degree) hybrid coupler, a (unequal) power splitter/divider, or any other suitable device.

The feedback signal output from feedback receiver 32 in circuitry 64 to processor(s) 26 may be used, in conjunction with the corresponding transmit signal, by processor(s) 26 for a number of applications. As examples, the feedback signal and the transmit signal based on which the feedback signal is generated may be used to perform adaptive (digital) pre-distortion for transmit signals, may be used for error vector magnitude (EVM) estimation, may be used as impedance measurements to characterize wireless communication circuitry performance.

To be useful in these applications, the feedback signal may need to be properly aligned (temporally) with the transmit signal. To illustrate this, consider an example in which a portion of the feedback signal is generated based on a corresponding portion of the transmit signal. The portion of the transmit signal may pass a reference point in transmit path circuitry 60 (e.g., within the digital front end of transmitter 30) at a first time, while the corresponding portion of the feedback signal may be output from feedback path circuitry 64 (e.g., by feedback receiver 32) at a second time. The difference in time or the time delay between the first time and the second time is the time it takes for the portion of the transmit signal to propagate through (at least a portion of) the transmit path to radio-frequency coupler 62 and the time it takes for the portion of the feedback signal to propagate through (at least a portion of) the feedback path.

Accordingly, the corresponding transmit signal conveyed as a reference to the feedback signal may first be delayed before being sent along the feedback path to processor(s) 26. To properly delay the transmit signal to be received by processor(s) 26 (and thereby aligning the transmit and feedback signals), time delay circuitry 66 may be coupled to transmit path circuitry 60 may delay the reference transmit signal prior to being conveyed to feedback path circuitry 64 and ultimately to processor(s) 26 along with the feedback signal.

As an example, time delay circuitry 66 may be coupled to a reference terminal in the digital front end portion of transmitter 30 along the transmit path and may be coupled to output interface or connector circuitry between feedback receiver 32 and processor(s) 26. The output interface circuitry may supply the time-delayed transmit signal and the feedback signal to processor(s) 26. If desired, time delay circuitry 66 may directly supply the time-delayed transmit signal to processor(s) 26. If desired, time delay circuitry 66 may store different time delay settings (e.g., different time delays) for different operating conditions (e.g., different RATs, different radio-frequency bands or channels, etc.) and apply a corresponding time delay based on the operating condition. If desired, the time delay may be applied in other manners to the reference transmit signal.

Time delay measurement circuitry (sometimes referred to herein as delay measurement circuitry or time delay determination circuitry) may be used to measure or otherwise determine the appropriate time delay settings to be applied to the time delay circuitry 66 to delay the transmit signal by the appropriate time delay and temporally align the transmit signal with the feedback signal. While some time delay measurement circuitry can sweep through each possible time delay and determine the appropriate time delay (via cross-correlation results) from the sweep to produce the appropriate time delay result, the sweep can take a long period of time. A binary search approach to speed up the process of determining the appropriate time delay may not always be possible given that the cross-correlation function can have local minima, which would impair the result (e.g., lead to an incorrect time delay result).

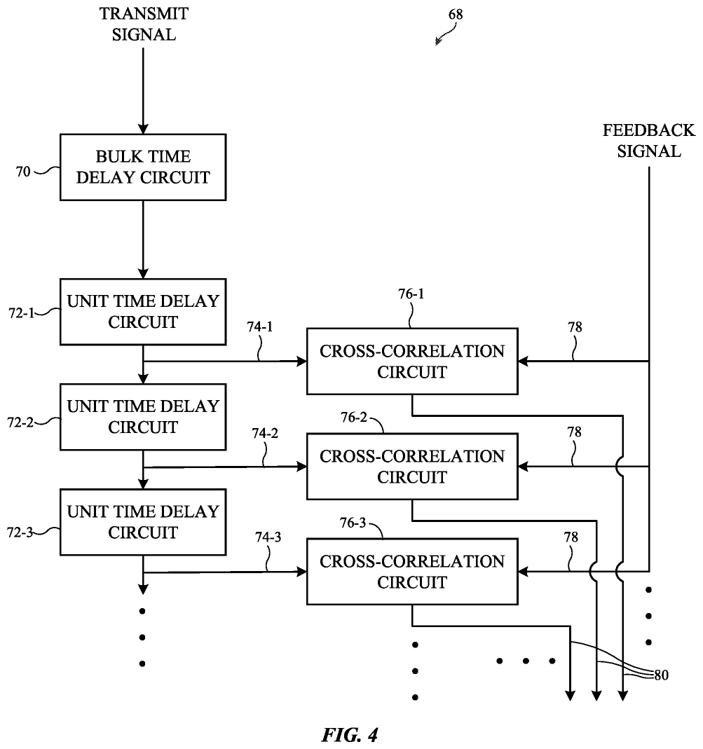

Accordingly, it may be desirable to provide time delay measurement circuitry that speeds up the measurement process without compromising the accuracy of the time delay result. FIG. 4 is a diagram of illustrative delay measurement circuitry can perform parallel cross-correlation measurements to speed up the delay determination process.

As shown in FIG. 4, delay measurement or determination circuitry 68 may include serially-coupled bulk time delay circuit 70 and multiple unit time delay circuits 72 (e.g., circuits 72-1, 72-2, 72-3, etc.). The input of time delay circuit 70 may be coupled to the transmit path (e.g., at a reference point in transmitter 30). Time delay circuit 70 may receive the transmit signal, for example in IQ (cartesian) format, or amplitude and phase, or other possible representations, and in combination with the unit time delay circuits 72, produce time-delayed versions of the transmit signal delayed by different amounts on paths 74 (e.g., paths 74-1, 74-2, 74-3, etc.).

Bulk time delay circuit 70 may provide a first (e.g., larger) time delay. As an example, the first delay applied by bulk time delay circuit 70 may be representative of the minimum time delay possible between the reference transmit signal and the feedback signal (e.g., an inherent time delay caused by portions of transmit path circuitry and/or feedback path circuitry that operate with large time delays). Unit time delay circuits 72 may each provide a second (e.g., smaller) delay that serves as steps in a time delay resolution. In other words, unit time delay circuits 72 may each apply a same unit delay.

In one illustrative arrangement, the time delay applied by bulk time delay circuit 70 may be 250 ns, while the time delay applied by each unit time delay circuit 72 may be 50 ns. In this arrangement, the transmit signal may be delayed by 300 ns, 350 ns, and 400 ns (e.g., as provided on paths 74-1, 74-2, and 74-3, respectively). If desired, any other suitable amounts of delay may be provided by time delay circuits 70 and 72. If desired, the amount of delay provided by each time delay circuit 70 and 72 may be adjustable.

If desired, bulk time delay circuit 70 and unit time delay circuits 72-1, 72-2, 72-3, etc. may sometimes be referred to herein collectively as time delay circuitry. This time delay circuitry (formed from bulk and unit time delay circuits 70 and 72) may implement time delay circuitry 66 in FIG. 3. In other words, other elements in time delay measurement circuitry 68 (in FIG. 4) may be coupled to time delay circuitry 66 in FIG. 3. In other arrangements, the time delay circuitry formed from bulk and unit time delay circuits 70 and 72 may be separate from time delay circuitry 66 in FIG. 3.

Differently delayed versions of the transmit signal on paths 74 may be cross-correlated with the same feedback signal at cross-correlation circuits 76 (sometimes referred to as cross-correlator 76 or correlator 76). In particular, cross-correlation circuit 76-1 may be coupled to an output (terminal) of unit time delay circuit 72-1 via path 74-1 and may be coupled to the feedback path (e.g., at a reference point at an output of feedback receiver 32) via path 78. Cross-correlation circuit 76-2 may be coupled to an output (terminal) of unit time delay circuit 72-2 via path 74-2 and may be coupled to the feedback path via path 78. Cross-correlation circuit 76-3 may be coupled to an output (terminal) of unit time delay circuit 72-3 via path 74-3 and may be coupled to the feedback path via path 78.

In some arrangements described herein as an example, each cross-correlation circuit 76 may include a multiplier coupled to an accumulator (or integrator). The multiplier may receive the time-delayed transmit signal on a corresponding path 74 and the feedback signal on path 78 as two inputs and provide their product as an output, which is then supplied to the accumulator. The accumulator may sum these products generated over a certain time period to generate an output (e.g., a cross-correlation result) for cross-correlation circuit 76. Configurations in which the multiplier and accumulator operations are performed on the amplitudes of the time-delayed reference transmit signal and the feedback signal (e.g., performed in the amplitude domain) are described herein as an illustrative example. If desired, other types of cross-correlation circuits may be used. As examples, the time-delayed reference transmit signal and the feedback signal received by cross-correlation circuit 76 may be in in-phase and quadrature (I/Q) representation, in a phase domain, or in a frequency domain.

Based on performing these cross-correlation operations, each cross-correlation circuit 76 may produce an output (e.g., a cross-correlation result) on path 80. The largest value from the results of cross-correlation circuits 76 may be indicative of the appropriate time delay (e.g., a best current estimate of the time delay). In other words, the time-delayed transmit signal received by the cross-correlation circuit 76 that yields the largest cross-correlation result may be appropriately delayed. As an example, if there are only three cross-correlation circuits 76-1, 76-2, and 76-3 and the output of cross-correlation circuit 76-2 is the largest, the combined delays of delay circuits 70, 72-1, and 72-2 may be the appropriate time delay to be applied at time delay circuitry 66 in FIG. 3.

If desired, processing circuitry 26 may be coupled to paths 80 and configured to receive outputs of cross-correlation circuits 76. Accordingly, processing circuitry 26 may perform the comparison and corresponding time delay determination operations described above.

The arrangement of delay measurement circuitry 68 having three sets of unit time delay circuits and cross-correlation circuits is illustrative of one of many possible configurations. If desired, any set of unit time delay circuit and cross-correlation circuit pairs may be employed in delay measurement circuitry 68. In practice, a large number (e.g., on the order of hundreds, thousands, etc.) of differently delayed transmit signals may be needed to cover all possible time delays with sufficient resolution to arrive at the appropriate time delay to be applied to the transmit signal to be conveyed with the feedback signal to processing circuitry 26.

While the configuration of delay measurement circuitry 68 in FIG. 4 enables parallel measurements (e.g., performing cross-correlation operations of differently delayed transmit signals in parallel) to quicken time delay determination, this comes at a cost of physical area, e.g., to implement a plurality of unit time delay circuits 70 coupled in series and a plurality of parallel cross-correlation circuits 76.

For applications in which only a few of sets of unit time delay circuits and cross-correlation circuits are needed and/or physical area is not a constraint, time delay measurement circuitry 68 in FIG. 4 may provide satisfactory performance (e.g., improved delay measurement speed). However, it may be desirable to further provide time delay measurement circuitry without these area constraints.

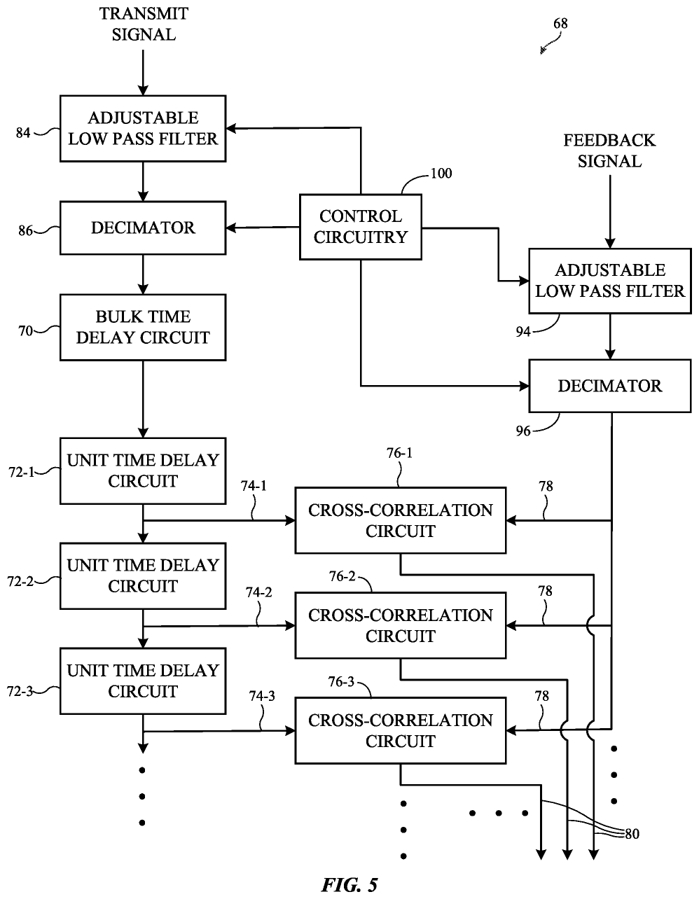

Accordingly, FIG. 5 shows an illustrative time delay measurement circuitry configured to perform an iteratively search for the time delay to quicken delay measurement while omitting excess unit time delay circuits and cross-correlation circuits that would otherwise take up large amounts of physical area.

As shown in FIG. 5, a filter such as an adjustable low pass filter 84 and a decimator 86 may be coupled between the transmit path (e.g., the reference terminal in transmitter 30 supplying the transmit signal) and the series of bulk and unit time delay circuits 70 and 72. Similarly, another filter such as an adjustable low pass filter 94 and a decimator 96 may be coupled between the feedback path and cross-correlation circuits 76.

Filters 84 and 86 may both be adjustable (e.g., exhibit an adjustable filter bandwidth to filter out larger or smaller sets of frequencies). In particular, a control circuit 100 (e.g., implemented on one or more processors 26, processing circuitry 18, a separate microcontroller or other processor circuit, etc.) may provide control signals to filters 84 and 94 to control the bandwidth of operation for filters 84 and 94 (e.g., the control signals may indicate the desired bandwidth of operation during different iterations of delay measurement).

Decimators 86 and 96 may both be adjustable (e.g., have an adjustable decimation factor based on which the decimation or down-sampling operation is performed). In particular, control circuit 100 may provide control signals to decimators 86 and 96. The control signals may indicate the desired decimation factor (or down-sampling rate) for operating decimators 86 and 96 (e.g., during different iterations of delay measurement).

Filters 84 and 94 may be controlled by control circuit 100 to operate in a synchronized manner. In other words, when filter 84 is configured (e.g., by a control signal received from control circuit 100) to exhibit a bandwidth when filtering the transmit signal, filter 94 may be configured (e.g., by a control signal received from control circuit 100) to have a same transfer function (sometimes referred to as a same transfer characteristic), e.g., imparted by having the same bandwidth, the same order, the same implementation, etc., as filter 84 when filtering the corresponding feedback signal.

Similarly, decimators 86 and 96 may be controlled by control circuit 100 to operate in a synchronized manner. In other words, when decimator 86 is configured (e.g., by a control signal received from control circuit 100) to exhibit a decimation factor when decimating (e.g., down-sampling) the transmit signal, decimator 96 may be configured (e.g., by a control signal received from control circuit 100) to exhibit the same decimation factor as decimator 86 when decimating the corresponding feedback signal. Decimators 86 and 96 should also be configured to sample portions of the reference transmit radio-frequency signal and portions the measured feedback radio-frequency signal that are aligned in time (e.g., as received by delay measurement circuitry 68).

Because the decimation and low pass filtering operations are synchronized when applied to the transmit signal and the feedback signal. The subsequent determination of the appropriate time delay as described in connection with FIG. 4 may be unaffected. In other words, the time delay found using the un-decimated and un-filtered transmit and feedback signals may be the same as the time delay found using the decimated and filtered transmit and feedback signals, when decimation and low pass filtering operations are synchronized.

The structure and function of time delay circuits 70 and 72 and cross-correlation circuits 76 are similar to those already described in connection with FIG. 4 and are not reiterated in detail to avoid obscuring the present embodiments in connection with FIG. 5.

In particular, the delay provided by each of time delay circuits 70 and 72 may also be adjustable. If desired, control circuit 100 may also provide control signals to one or more time delay circuits 70 and 72 to adjust the bulk delay of delay circuit 70 and/or the unit delay of delay circuits 72.

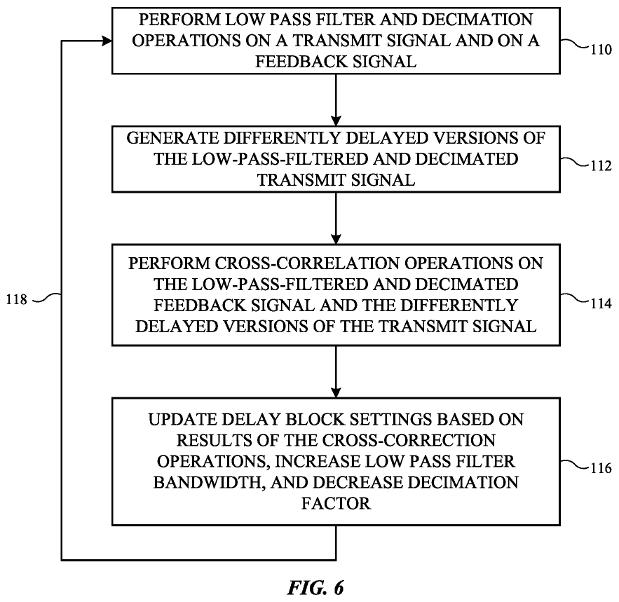

Configured in this manner, delay measurement circuitry 68 in FIG. 5 may be operable to perform the delay measurement or determination operation based on an iterative search approach. FIG. 6 is a flowchart of illustrative operations used by delay measurement circuitry such as delay measurement circuitry 68 in FIG. 5 to perform delay measurement based on making parallel cross-correlation measurements across multiple iterations.

As shown in FIG. 6, at block 110, delay measurement circuitry 68 (e.g., filter 84 exhibiting a first bandwidth) may perform a (low pass) filter operation on the transmit signal to reduce the bandwidth of the transmit signal. Delay measurement circuitry 68 (e.g., filter 94 exhibiting the same first bandwidth) may perform a (low pass) filter operation on the transmit signal to reduce the bandwidth of the feedback signal by the same degree (e.g., due to the same bandwidths of filters 84 and 94).

Further at block 110, delay measurement circuitry 68 (e.g., decimator 86 operating with a first decimation factor) may perform a decimation (down-sampling) operation on the filtered (reduced-bandwidth) transmit signal to down-sample the filtered transmit signal. Delay measurement circuitry 68 (e.g., decimator 96 operating with the same first decimation factor) may perform a decimation operation on the filtered (reduced-bandwidth) feedback signal to down-sample the filtered feedback signal with the same sampling rate (e.g., due to the same decimation factors of decimators 86 and 96). Decimators 86 and 96 should be synchronized such that the selected samples of signals on both the reference transmit path and the measured feedback path are time-aligned.

At block 112, delay measurement circuitry 68 (e.g., bulk time delay circuit 70 and unit time delay circuits 72-1, 72-2, and 72-3 in the example of FIG. 5) may delay the decimated and filtered transmit signal by different amounts to generate differently delayed versions of the decimated and filtered transmit signal on corresponding paths 74 (in FIG. 5).

At block 114, delay measurement circuitry 68 (e.g., cross-correlation circuits 76) may correlate each delayed version of the decimated and filtered transmit signal to the same decimated and filtered feedback signal. In particular, the cross-correlation operation may be performed by integrating the products of its two inputs over a particular (pre-defined) time period. The cross-correlation operation between the differently delayed versions of the decimated and filtered transmit signal and the same decimated and filtered feedback signal may be performed in parallel (e.g., using parallel cross-correlation circuits 76-1, 76-2, and 76-3 in the example of FIG. 5).

Delay measurement circuitry 68 (e.g., a control circuit such as control circuit 100) may receive the cross-correlation results via the output terminals of cross-correlation circuits 76 (e.g., coupled to the control circuit).

At block 116, delay measurement circuitry 68 (e.g., control circuit 100) may update time delay settings implemented by bulk time delay circuit 70 and/or unit time delay circuits 72 based on the results of the cross-correlation operation performed at block 114. Delay measurement circuitry 68 (e.g., control circuit 100) may also update (e.g., increase) the synchronized bandwidths of filters 84 and 94 and update (e.g., decrease) the synchronized decimation factors of decimators 86 and 96. The operations performed at block 116 may prepare delay measurement circuitry 68 for a further (subsequent) iteration of the operations at blocks 110, 112, and 114 and may be omitted if no further iterations are desired.

As described above in connection with block 110 during the first (initial or current) iteration, the synchronized low pass filters 84 and 94 may have the same first bandwidth. In preparation for the second (subsequent) iteration, the synchronized low pass filters 84 and 94 may both be adjusted via control circuit 100 to have a second bandwidth (e.g., a second bandwidth that is double the first bandwidth) when performing the operations at block 110 for the second iteration.

As described above in connection with block 110 during the first iteration, the synchronized decimators 86 and 96 may operate with the same first decimation factor (e.g., a decimation factor of 16, where every 16^{th} sample is kept during down-sampling). In preparation for the second iteration, the synchronized decimators 86 and 96 may both be adjusted via control circuit 100 to operate with a second decimation factor (e.g., a decimation factor that is half of the first decimation factor, a decimation factor of 8 where every 8^{th} sample is kept during down-sampling) when performing the operations at block 110 for the second iteration.

As described above in connection with block 112 during the first iteration, the time delay circuitry (e.g., time delay circuits 70 and 72) may operate with an initial set of delays (e.g., an initial bulk time delay exhibited by bulk time delay circuit 70 and an initial unit time delay exhibited by each of unit time delay circuits 72). In preparation for the second iteration, the initial bulk time delay exhibited by bulk time delay circuit 70 and/or the initial unit time delay exhibited by each of unit time delay circuits 72 may be updated. In particular, this update of time delays may be based on the results of the cross-correlation operation as part of block 114 for the first iteration.

As described above in connection with FIG. 4 with delayed versions of the (non-decimated and non-filtered) transmit signal, which are similarly applicable to FIGS. 5 and 6 with delayed versions of the (decimated and filtered) transmit signal, a particular delayed version of the (decimated and filtered) transmit signal may produce the largest cross-correlation output (value) out of all of the cross-correlation outputs computed in parallel for the first iteration. The particular delayed version of the (decimated and filtered) transmit signal producing the largest cross-correlation output may be indicative of the particular delayed version being closest to (e.g., a currently best delay estimate to) the actual delay between the transmit signal and the feedback signal.

Accordingly, the bulk time delay applied by bulk time delay circuit 70 may be updated for the second iteration based on the time delay applied to arrive at the particular delayed version of the transmit signal that produced the largest cross-correlation output (value) during the first iteration. The unit delay applied by unit delay blocks 72 may be updated (e.g., halved) to perform a time delay determination or search with finer temporal resolution during the second iteration (as compared to the first iteration). As an example, the updated set of (bulk and unit) time delays may produce delayed versions of the transmit signal centered at the currently best delay estimate (as estimated during the first or current iteration) with smaller unit time steps, thereby providing higher temporal resolution.

Following a current iteration of the operations at blocks 110-114 and the preparation for a subsequent iteration of the operations at block 116, processing can proceed via path 118 to begin the subsequent iteration of the operations at blocks 110-114.

In such a manner, delay measurement circuitry 68 may perform multiple (third, fourth, fifth, etc.) iterations of operations at blocks 110-116 using path 118 to arrive at a better time delay estimate after each iteration. Each subsequent iteration of delay measurement may be performed with a higher filter bandwidth, a lower decimation factor, a bulk time delay with an improved time delay estimate, and/or a smaller unit time delay with better resolution. Delay measurement circuitry 68 may perform any suitable number of iterations of delay measurement such five iterations, four iterations, more than five iterations, etc. and may provide the final time delay (estimate) after a final iteration to time delay circuitry 66 in FIG. 3 for storage and/or use.

Configured and/or operated in the manner described in connection with FIGS. 5 and/or 6, delay measurement circuitry 68 may use parallel computations of cross-correlation across multiple iterations to ultimately arrive at a final time delay to be applied to the transmit signal supplied to processor(s) 26 along with the feedback signal. The use of filters 84 and 86 may help smoothen (decrease the bandwidth of) the transmit and feedback signals during measurement in order to avoid arriving at local minima solutions from the cross-correlation operations. The inclusion of decimators 86 and 96 and adjustable (bulk and unit) time delay circuits may help enable this iteratively approach to converge at the final time delay after a desired number of iterations have been performed (e.g., when a threshold number of iterations is reached).

The methods and operations described above in connection with FIGS. 1-6 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 and/or wireless communications circuitry 24 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry in wireless circuitry 24, processing circuitry 18 of FIG. 1, etc.). The processing circuitry may include microprocessors, application processors, digital signal processors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

What is claimed is:

1. Delay measurement circuitry comprising:
a first time delay circuit of a plurality of time delay circuit configured to receive a first radio-frequency signal;
a plurality of cross-correlation circuits coupled to corresponding time delay circuits in the plurality of time delay circuits and configured to receive a second radio-frequency signal; and
one or more processors coupled to the plurality of cross-correlation circuits and configured to determine a time delay between the first radio-frequency signal and the second radio-frequency signal based at least in part on cross-correlation results generated at the plurality of cross-correlation circuits.

2. The delay measurement circuitry of claim 1 further comprising:
a first decimator coupled to the first time delay circuit; and
a second decimator coupled to each cross-correlation circuit in the plurality of cross-correlation circuits.

3. The delay measurement circuitry of claim 2 further comprising:
a first filter coupled to the first decimator, wherein the first radio-frequency signal is a decimated and filtered version of an original first radio-frequency signal; and
a second filter coupled to the second decimator, wherein the second radio-frequency signal is a decimated and filtered version of an original second radio-frequency signal.

4. The delay measurement circuitry of claim 3, wherein the first decimator and the second decimator are synchronized in operation to exhibit a same decimation factor and respectively configured to sample a portion of the first radio-frequency signal and a portion of the second radio-frequency signal that are aligned in time.

5. The delay measurement circuitry of claim 4, wherein the first filter and the second filter are synchronized in operation to exhibit a same transfer characteristic.

6. The delay measurement circuitry of claim 5, wherein the plurality of time delay circuits are configured to apply a first set of time delays during a first iteration of delay measurements and the plurality of delay circuits are configured to apply a second set of time delays during a second iteration of delay measurements.

7. The delay measurement circuitry of claim 6, wherein the first decimator and the second decimator are configured to operate with a first decimation factor during the first iteration of delay measurements and a second decimation factor less than the first decimation factor during the second iteration of delay measurements.

8. The delay measurement circuitry of claim 7, wherein the first filter and the second filter are configured to operate with a first bandwidth during the first iteration of delay measurements and a second bandwidth greater than the first bandwidth during the second iteration of delay measurements.

9. The delay measurement circuitry of claim 3, wherein the first filter comprises a first low pass filter and the second filter comprises a second low pass filter.

10. The delay measurement circuitry of claim 1, wherein the first time delay circuit is a bulk time delay circuit configured to apply a first time delay and the plurality of time delay circuits further include unit time delay circuits each configured to apply a same second time delay.

11. The delay measurement circuitry of claim 10, wherein each of the unit time delay circuits has an output terminal coupled to a corresponding cross-correlation circuit in the plurality of cross-correlation circuits.

12. The delay measurement circuitry of claim 1, wherein the first radio-frequency signal is a transmit signal from a radio-frequency transmitter and the second radio-frequency signal is a feedback signal from a radio-frequency feedback receiver.

13. Wireless circuitry comprising:
a transmitter;
a feedback receiver coupled to the transmitter via a radio-frequency coupler;
one or more processors configured to receive a feedback signal from the feedback receiver and a delayed transmit signal applied with a time delay from the transmitter; and
time delay measurement circuitry configured to determine the time delay, the time delay measurement circuitry including
time delay circuitry configured to receive a transmit signal, and
a plurality of cross-correlation circuits each coupled to the time delay circuitry and each configured to receive the feedback signal.

14. The wireless circuitry of claim 13, wherein the time delay measurement circuitry comprises a first filter coupled to the time delay circuitry, a second filter coupled to each cross-correlation circuit in the plurality of cross-correlation circuits, and the first filter and the second filter are synchronized to exhibit a same bandwidth.

15. The wireless circuitry of claim 14, wherein the time delay measurement circuitry comprises a first decimator coupled to the time delay circuitry, a second decimator coupled to each cross-correlation circuit in the plurality of cross-correlation circuits, and the first decimator and the second decimator are synchronized to exhibit a same decimation factor.

16. The wireless circuitry of claim 13, wherein each cross-correlation circuit in the plurality of cross-correlation circuits includes a multiplier and an accumulator coupled to the multiplier.

17. The wireless circuitry of claim 13, wherein the time delay circuitry comprises a bulk time delay circuit applying a first time delay and a plurality of unit time delay circuits each applying a same second time delay and wherein the bulk time delay circuit and the plurality of unit time delay circuits are coupled in series.

18. A method of time delay determination comprising:
filtering a first radio-frequency signal;
decimating the filtered first radio-frequency signal;
delaying the decimated and filtered first radio-frequency signal;
filtering a second radio-frequency signal;
decimating the filtered second radio-frequency signal; and
determining a time delay between the first radio-frequency signal and the second radio-frequency signal based at least in part on cross-correlating the delayed, decimated, and filtered first radio-frequency signal and the decimated and filtered second radio-frequency signal.

19. The method of claim 18, wherein filtering the first radio-frequency signal comprises filtering the first radio-frequency signal via a first filter bandwidth during a first iteration and filtering the first radio-frequency signal via a second filter bandwidth during a second iteration and wherein filtering the second radio-frequency signal comprises filtering the second radio-frequency signal via the first filter bandwidth during the first iteration and filtering the first radio-frequency signal via the second filter bandwidth during the second iteration.

20. The method of claim 19, wherein decimating the filtered first radio-frequency signal comprises decimating the filtered first radio-frequency signal via a first decimation factor during the first iteration and decimating the filtered first radio-frequency signal via a second decimation factor during the second iteration and wherein decimating the filtered second radio-frequency signal comprises decimating the filtered second radio-frequency signal via the first decimation factor during the first iteration and decimating the filtered second radio-frequency signal via the second decimation factor during the second iteration.
